(19) United States
(12) Patent Application Publication
(10) Pub. No.: US 2006/0212885 A1
(43) Pub. Date: Sep. 21, 2006

(54) Optical disk apparatus

(76) Inventors: Hideyuki Onuma, Hokota (JP); Seiji Hamaie, Ebina (JP); Sojiro Kirihara, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/216,065

(22) Filed: Sep. 1, 2005

(30) Foreign Application Priority Data
Mar. 18, 2005 (JP) 2005-079688

(51) Int. Cl. G11B 17/04

(52) U.S. Cl. 720/622

(57) ABSTRACT

In an optical disk apparatus, a cover that covers a unit mechanism is adapted to be movable about a supporting point, and when an optical disk is loaded into the apparatus, the front edge of the optical disk loaded will abut on the plane of the cover inclined in a crossing direction with respect to the plane of the optical disk, and the resulting repulsion from the plane of the cover will regulate the vertical position of the recording surface of the optical disk to ensure desired height of the recording surface.

### CLAIM OF PRIORITY

The present application claims priority from Japanese application Ser. No. P2005-079688, filed on Mar. 18, 2005, the content of which is hereby incorporated by reference into this application.

### BACKGROUND OF THE INVENTION

1. Technical Field of The Invention

The present invention relates to optical disk apparatuses that write information onto or read it out from optical disks, and more particularly, to a technique for reducing the apparatuses in thickness.

2. DESCRIPTION OF THE RELATED ART

FIG. 9 illustrates a conventional optical disk apparatus by way of example. In FIG. 9, when loaded into the apparatus, an optical disk (not shown) is loaded from the disk loading/unloading slot within a front panel 7′ and then moved in toward the depths of the apparatus while being supported at an outer circumferential section, and being centered by members such as a guide 142 present on the lever 131 turning about a supporting point 131a, a guide 141 on the lever 135 turning about a supporting point 135a, and a guide 144 on the lever 133 turning about a supporting point 133a. When it reaches a desired position within the apparatus, the optical disk is rested on a disk plane support section 2a ′ by the pivotal movement of a traverse (unit mechanism) having an optical pickup 4′ (including an objective lens 4a′), a disk motor 2′, and other members mounted thereon, and then the disk is chucked into position. A guide shaft 150 is adapted to support the lever 131 by abutting on the lower face of the lever 131 when the lever turns, regulate the height position of the recording surface of the optical disk during its loading or unloading, and thus prevent the recording surface from suffering damage or the like due to contact with a damper 3′ or the like. One cover 6′ is fixedly provided on the traverse in order to protect its components such as the mechanical section for moving the optical pickup 4′.

Bibliographed conventional techniques associated with the present invention include those described in, for example, Japanese Patent Laid-open Nos. 2002-352498 and 2004-39193. Japanese Patent Laid-open No. 2002-352498 describes the configuration of a disk apparatus capable of being reduced in the dimensions that includes thickness. In this configuration, a spindle motor, a pickup, and driving means for moving the pickup are retained by a traverse, the spindle motor is disposed centrally on a base body, and the traverse adapted to pivot around a supporting point is disposed on the disk-loading slot side. Also, the disk when loaded into the apparatus is supported by disk guides 17, 81 fixed on the base body side, a guide 112 provided on a regulating lever 110, and/or a guide 101 provided on an unloading lever 100. Japanese Patent Laid- open No. 2004-39193 describes the configuration of a disk release mechanism in a disk apparatus device for achieving reduction in the dimensions that include thickness. In this configuration, a disk cover that locks and retains the disk when it is released is provided on the same side as that of a disk spindle, with respect to the disk, and the disk when loaded into the apparatus is supported by members such as pin A provided on a disk slider 19, pin B provided on a disk arm 20, and/or pin C provided on a sensor link 24.

Of the above conventional techniques, the technique based on the configuration of FIG. 9 requires the guide shaft 150 for ensuring the height position of the optical disk, so this technique is liable to increase the thickness of the apparatus and thus makes thickness reduction not easily achievable. Also, the technique described in Japanese Patent Laid-Open No. 2002-352498 is based on the configuration in which the guide 112 on the regulating lever 119, the guide 101 on the unloading lever 100, and/or other members are used to support the disk when it is loaded into the apparatus; therefore, it becomes difficult to ensure the desired height position of the optical disk after the regulating lever 110 and/or the unloading lever 100 has turned in a vertically moved condition. In addition, the technique described in Japanese Patent Laid-open No. 2004-39193 is based on the configuration in which pin A provided on a disk slider 19, pin B provided on a disk arm 20, pin C provided on a sensor link 24, and/or other members are used to support the disk when it is loaded into the apparatus; therefore, it is difficult to ensure the desired height position of the disk after the disk slider 19, the disk arm 20, the sensor link 24, and/or other members have turned in a vertically moved condition.

The present invention allows for the situations of the above conventional techniques, and the invention is intended to make it possible to provide, for instance, among all slot-in types of optical disk apparatuses, i.e., the types that allow direct loading of a disk as a recording medium into the apparatus without using a tray, a casing, or the like, particularly the optical disk apparatus of the slim slot type (or the like) that can ensure a height position of a disk surface, even during optical-disk loading into and unloading from the optical disk apparatus, and achieve dimensional reduction of the apparatus, especially, further reduction of its thickness to 9.5×10⁻³ m or less, for example, under a safe structure not damaging the disk surface.

### SUMMARY OF THE INVENTION

The present invention is an optical disk apparatus that solves problems associated with the conventional techniques.

More specifically, the optical disk apparatus of the present invention is basically constructed such that a cover that covers a unit mechanism can be moved about a supporting point, and when an optical disk is loaded into the apparatus, a front end of the optical disk loaded is made to abut on a plane of the cover inclined in a crossing direction with respect to a plane of the disk, and repulsion from the plane of the cover changing in position regulates a height position of a recording surface of the disk to ensure a desired height position.

Alternatively, the optical disk apparatus of the present invention is basically constructed such that: a cover that covers a unit mechanism can be moved about a supporting point; a lifter is provided which, prior to chucking, moves the cover about the supporting point by exerting force on the cover when an optical disk is in at least a desired position halfway on a disk-loading route inside the apparatus; when the optical disk is loaded into the apparatus, a front end of the optical disk is made to abut on a plane of the above cover inclined in a crossing direction with respect to a plane of the disk, and repulsion from the plane of the cover regulates a height position of a recording surface of the disk; when the disk is in a desired loading position, the lifter moves the cover in the direction where the plane thereof is spaced apart from the disk.

According to the present invention, an optical disk apparatus of the slot-in type or the like can be dimensionally reduced, especially, further reduced in thickness.

### BRIEF DESCRIPTION OF THE DRAWINGS

FIG. 1 illustrates an optical disk apparatus according to an embodiment of the present invention by way of configurational example;

FIG. 2 is a plan view of an internal configuration of the optical disk apparatus shown in FIG. 1;

FIG. 3 is a plan view showing a configuration of a unit mechanism in the optical disk apparatus of FIG. 1;

FIGS. 4A and 4B are explanatory diagrams of disk loading in the optical disk apparatus of FIG. 1;

FIG. 5 is a diagram showing the relationship in height between various sections during disk loading in FIGS. 4A and 4B;

FIG. 6 is an enlarged view of a lifter which moves vertically a cover for covering the unit mechanism in the optical disk apparatus of FIG. 1;

FIGS. 7A, 7B and 7C are operation explanatory diagrams of the lifter of FIG. 6;

FIG. 8 is an explanatory diagram of disk chucking in the optical disk apparatus of FIG. 1; and

FIG. 9 illustrates an example of a conventional technique.

### DETAILED DESCRIPTION OF THE PREFERRED EMBODIMENTS

An embodiment of the present invention will be described below using the accompanying drawings.

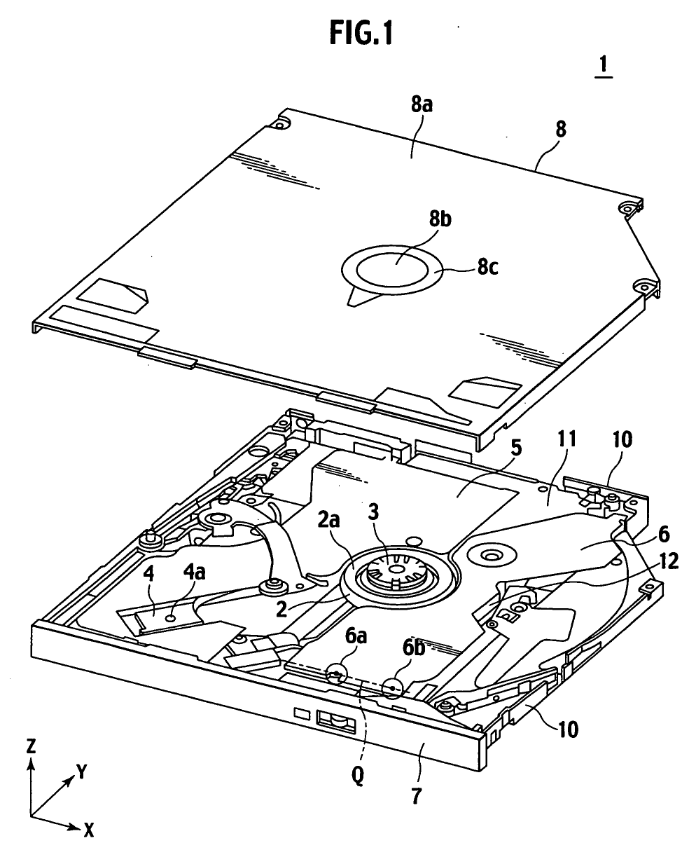

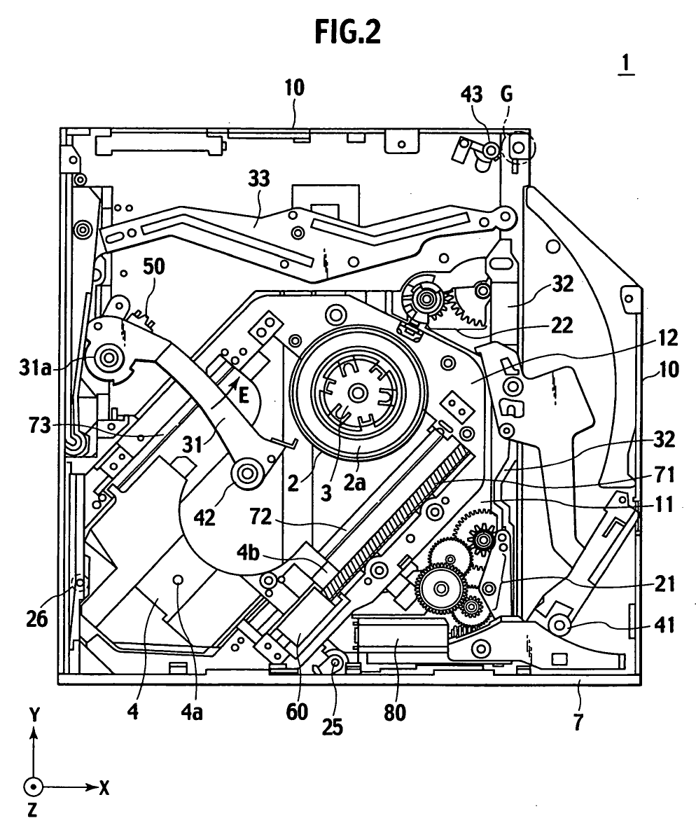

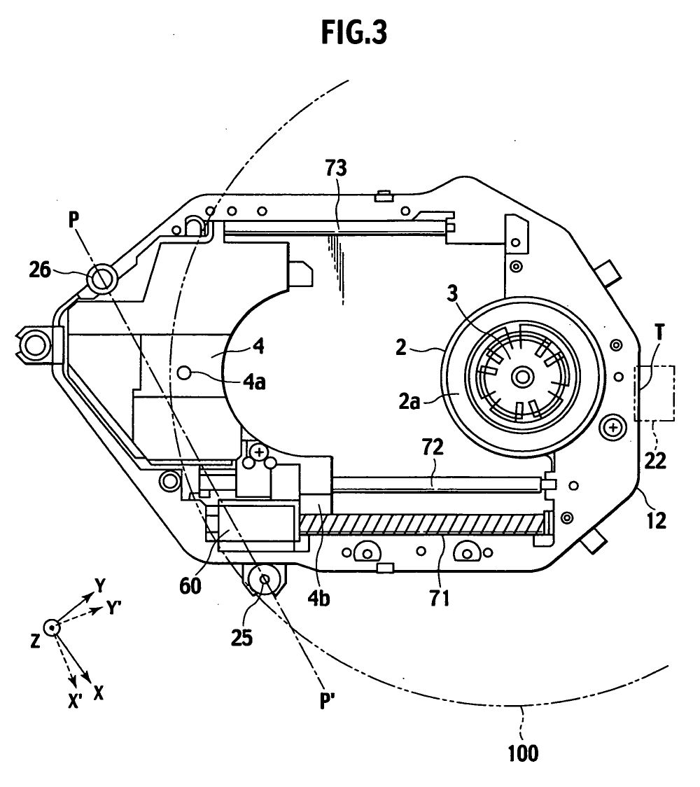

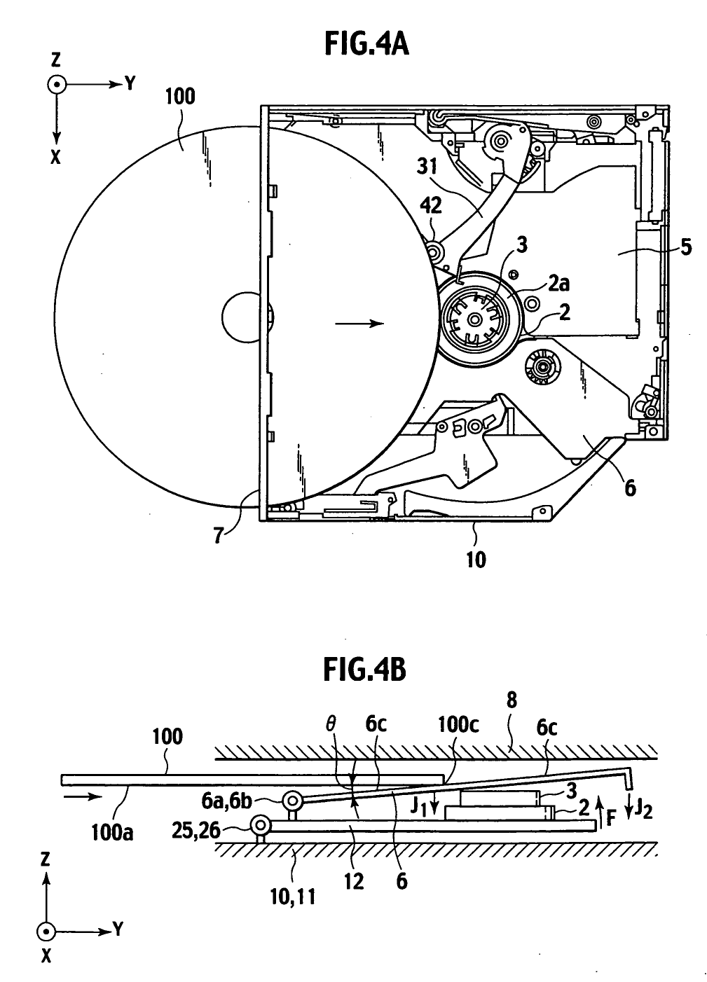

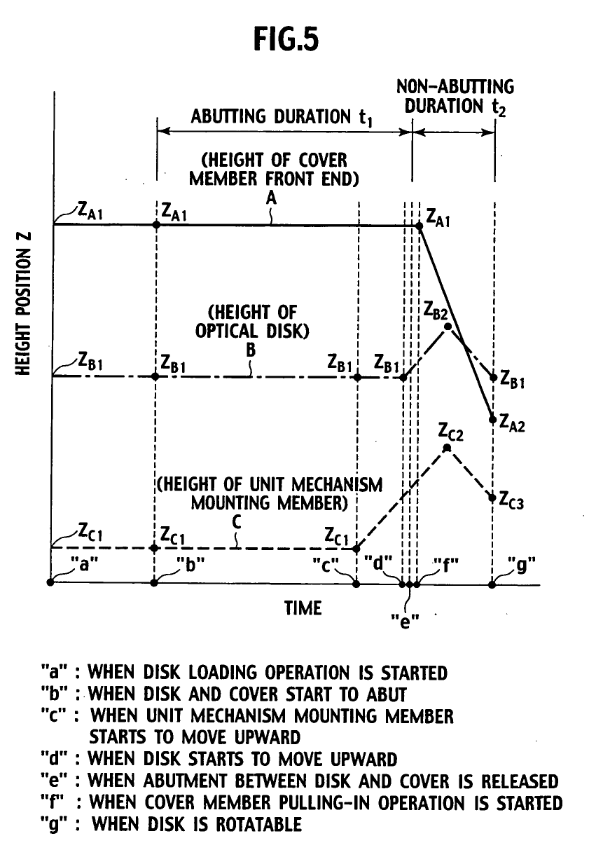

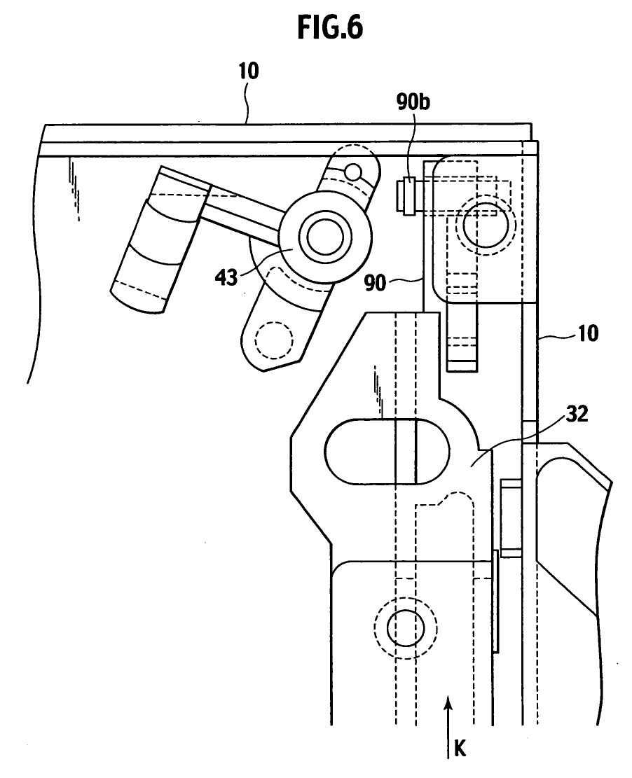

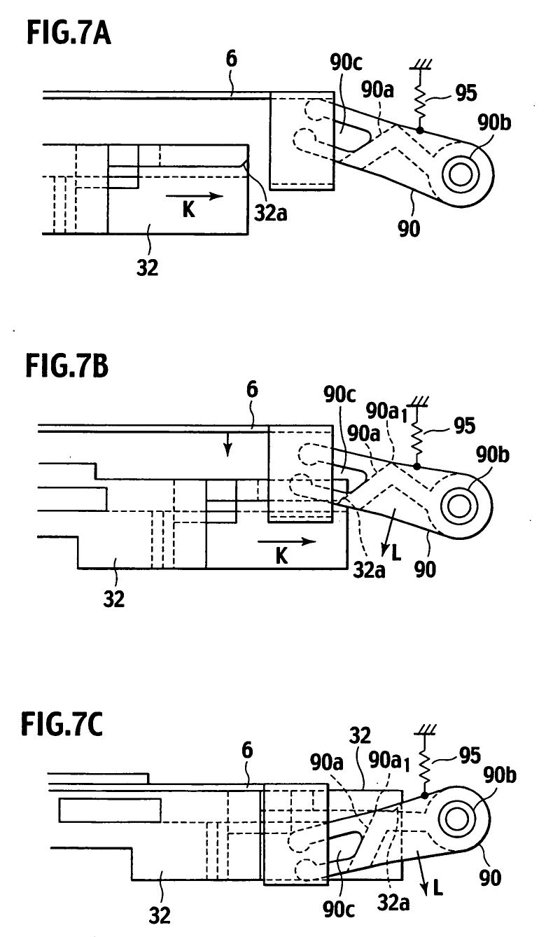

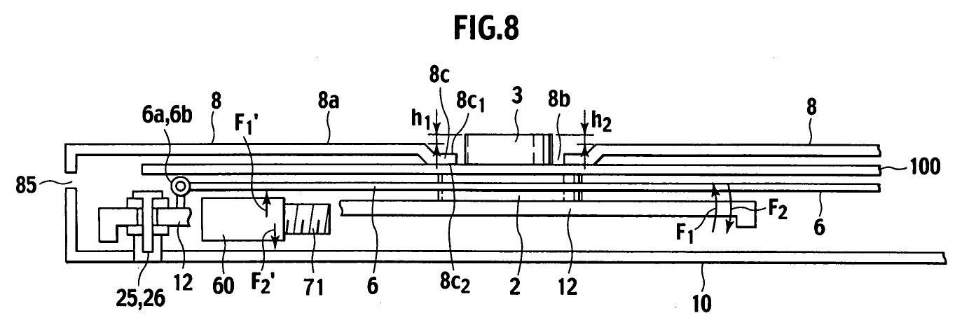

FIGS. 1 to 8 are explanatory diagrams of an embodiment of the present invention. FIG. 1 is a perspective view of a slot-in type of optical disk apparatus according to an embodiment of the present invention, with its top cover removed. FIG. 2 is a plan view of an internal structure of the optical disk apparatus shown in FIG. 1, and FIG. 3 is a plan view showing a configuration of a unit mechanism in the optical disk apparatus of FIG. 1. FIGS. 4A and 4B are explanatory diagrams of disk loading into the optical disk apparatus of FIG. 1, and FIG. 5 is a diagram showing the relationship in height between various sections during disk loading in FIGS. 4A and 4B. FIG. 6 is an enlarged view of a lifter which moves vertically a cover for covering the unit mechanism in the optical disk apparatus of FIG. 1, FIGS. 7A to 7C are operation explanatory diagrams of the lifter of FIG. 6, and FIG. 8 is an explanatory diagram of disk chucking in the optical disk apparatus of FIG. 1.

In FIG. 1, reference number 1 denotes an optical disk apparatus, 2 a disk motor for rotating an optical disk (not shown), and 3 a damper disposed at top of a rotating section of the disk motor 2 and having a convex-shaped constituent element which, when the optical disk is chucked, is inserted into a central hole of the optical disk and supports the disk. Reference number 2a denotes a disk plane support section disposed concentrically with the damper 3, at top of the rotating section of the disk motor 2, in order to support, with the damper 3 inserted within the central hole of the optical disk, a planar section (planar section on the recording surface side) provided around the central hole. Reference number 4 is an optical pickup that writes and/or reads information by irradiating a recording surface of the optical disk with a laser beam, and 4a is an objective lens. Reference numbers 5 and 6 are covers that cover a surrounding region within the unit mechanism of the apparatus, such as the disk motor 2, damper 3, and disk plane support section 2a, and provides spatial interception, in that region, between the planar section on the recording surface side of the optical disk and components/mechanism of the apparatus. Reference numbers 6a, 6b denote supporting points for turning of the cover 6, and symbol Q is a straight line passing through the two supporting points 6a and 6b (hereinafter, this line is referred to as the supporting- point line). Reference number 7 is a front panel of the optical disk apparatus 1, and 8 is a top cover disposed above the damper 3 and facing the surface of the optical disk apparatus 1 to cover this apparatus. Reference number 8a is an outside planar section (outer planar section) of the top cover 8, 8b a through-hole provided at a position opposite to the damper 3, on the surface of the top cover 8, and 8c a recess provided around the through-hole 8b. Reference number 10 is a bottom cover disposed on the reverse side of the optical disk apparatus 1 to cover the apparatus, 11 a first base forming a base of the apparatus and coupled with the bottom cover 10, and 12 a unit mechanism mounting member as a second base on which are installed the disk motor 2, the damper 3, the disk plane support section 2a, the optical pickup 4, and other elements.

The optical pickup 4 having the objective lens 4a mounted thereon is moved in approximately a radial direction with respect to the optical disk in its chucked condition, by a lead screw member (not shown) rotationally driven by a feed motor (not shown). Of the covers 5 and 6, the cover 6 has a movable construction and changes in position by turning about the supporting points (second supporting points) 6a and 6b (or about supporting-point line Q) when the optical disk is loaded and unloaded. The supporting points 6a and 6b are arranged at those positions on the disk outer circumferential side that are external to a midpoint position in the radial direction of the chucked optical disk (not shown), that is, to a radial intermediate position on the disk or a midpoint position between an inside diameter and outside diameter of the disk, in vicinity of the front panel 7. Although the configuration according to the present embodiment assumes that the supporting points 6a and 6b are provided on the unit mechanism mounting member 12, the present invention is not limited to this configuration and the supporting points 6a and 6b may be provided on the base 11, for example.

In FIG. 2, reference number 71 is a lead screw member having a feed screw on the surface thereof and rotating to assign approximately radial moving force of the optical disk to the optical pickup 4, and 60 is a feed motor, such as a stepping motor, that has a motor-rotating shaft directly coupled with the lead screw member 71 to rotationally drive the member 71. Reference numbers 72 and 73 are guide members for guiding an approximately radial movement of the optical pickup 4, on both sides of the pickup 4, and 4b is a rack with a front end engaged with the feed screw of the lead screw member 71 in order to transmit rotating force thereof to the optical pickup 4 as linear moving force. Reference numbers 31, 32, 33 are levers which, when the optical disk is loaded from the front panel 7 into the apparatus and when the optical disk within the apparatus is unloaded toward the front panel 7, transmit driving force for the load/unloading of the disk. Reference number 31a is a supporting-point member for turning of the lever 31. Reference numbers 41, 42 are rollers that abut on outer circumferential portions of the loaded optical disk in order to center the disk. Reference number 43 denotes an arm, 80 a motor, 50 a switch that turns supply of driving input power to the motor 80 on/off, and 21 a transmission for transmitting rotational driving force of the motor 80 to the lever 32. Reference number 22 denotes a lifter provided (as a first lifter) at the first base 11 in order to move the unit mechanism mounting member 12 vertically by giving pivotal moving force thereto with the optical disk loaded within a desired position of the apparatus during disk chucking. Reference numbers 25, 26 denote supporting points (first supporting points) for the unit mechanism mounting member 12 to change its vertical position by pivotal movement. Meanings of other reference numbers and symbols are the same as for FIG. 1.

A second lifter (not shown) that is actuated by the lever 32 and moves the cover 6 vertically about the second supporting points 6a and 6b (or about supporting-point line Q) is disposed at position G. The unit mechanism mounting member 12 changes in vertical position by turning around the supporting points 25 and 26. The feed motor 60, the lead screw member 71, the guide members 72 and 73, and other sections are also arranged, with the disk motor 2 and the damper 3, on the unit mechanism mounting member 12. Therefore, these sections are also moved vertically (i.e., changed in turning position) together with the unit mechanism mounting member 12 by the vertical movement thereof. The transmission 21 is equipped with a gear train. The roller 42 is provided on the. lever 31.

The lead screw member 71, the rack 4b, and the guide.members 72, 73 constitute a moving/guiding mechanism that moves the optical pickup 4 while guiding it in approximately the radial direction of the optical disk. The unit mechanism mounting member 12 and the constituent elements mounted thereon, such as the disk motor 2, damper 3, optical pickup 4, the above-mentioned moving/guiding mechanism, and feed motor 60, constitute the unit mechanism as a whole.

In the above construction, the directly-coupled driving type of feed motor 60 is disposed at that position on the disk outer circumferential side that is external to a midpoint position in the radial direction of the chucked optical disk (i.e., a radial intermediate position on the disk or a midpoint position between the inside diameter and outside diameter of the disk), in a projection region of the disk on the unit mechanism mounting member 12 (this region is where the optical disk creates a shadow thereof when orthogonally projected in a direction vertical to the disk plane; hereinafter, this region is referred to as the projection region or the disk projection region). That is to say, a position at a distance about half a radial length of a body of the feed motor 60 during turning becomes external to the midpoint position in the radial direction of the optical disk. Also, the supporting points 25 and 26 are provided on the outer circumferential side of the chucked optical disk, namely, externally to the midpoint position in the radial direction thereof (i.e., a radial intermediate position on the optical disk or s midpoint position between the inside diameter and outside diameter of the disk). In addition, the feed motor 60 is disposed at a position closer to the supporting point 25, 26, than to the midpoint position in the radial direction of the optical disk (i.e., a radial intermediate position on the optical disk or a midpoint position between the inside diameter and outside diameter of the disk), in the projection region of the disk. That is, the position at a distance about half the radial length of the body of the feed motor 60 during turning becomes closer to the supporting point 25 and 26 than to the midpoint position in the radial direction of the optical disk. Constructing each element in this way is effective for dimensional reduction, especially for reduction in thickness.

In the construction according to FIGS. 1 and 2, when the optical disk is loaded into the apparatus and chucked, the first lifter 22 lifts the unit mechanism mounting member 12 that functions as the second base, to a desired position by pivotally moving the member 12 about the supporting points 25, 26. After the optical disk has thus been made to abut on the face of the recess 8c of the top cover 8 that is opposed to the disk, a front edge of the damper 3 protrudes from the through-hole 8b in the top cover 8. Thus, the optical disk is held between the recess 8c in the top cover 8 and the disk plane support section 2a, and the disk is mounted into position at the damper 3. When the unit mechanism mounting member 12 is moved upward, the feed motor 60 is also moved upward at that position (position on the outer circumferential side of the optical disk or position near the supporting point 25, 26), together with the unit mechanism mounting member 12.

The present embodiment assumes that when the optical disk is loaded from a loading/unloading slot (not shown) within the front panel 7 into the optical disk apparatus 1, the movable cover 6 in an inclined state in a crossing direction with respect to the plane of the optical disk is urged beforehand for increased angle of the inclination, by resilience of a resilient member. The optical disk, after being loaded from the loading/unloading slot, has its front edge abutting on a plane of the cover 6, at a desired loading distance, and pushing the plane of the cover 6 against the above resilience. The disk then undergoes the resulting repulsion from the plane of the cover 6 and is regulated in a height position of the recording surface. Also, when the optical disk is loaded from the loading/unloading slot, the disk has its outer circumference caused to abut on the rollers 41, 42, and the arm 43, in that order. The disk is thus centered while changing each of the levers 31, 32, 33 in position. At this time, the roller 42 is pushed by the outer circumference of the optical disk loaded, and thus turns the lever 31 about a supporting point on the supporting-point member 31a, in a direction of arrow E.

The lever 31 activates the switch 50 when a desired variation in a turning position of the lever 31 in the direction of arrow E is reached. When the switch 50 is activated, desired driving input power is supplied from a driver (not shown) to the motor 80 to rotate this motor. When the motor 80 starts rotating, its rotational driving force is transmitted to the lever 32 by the transmission 21. The lever 32 transfers the transmitted force to the first lifter 22.

When the optical disk is halfway on its loading route, the lever 32 is actuated by the force transferred from the transmission 21, and drives the second lifter (not shown) disposed at position G. The second lifter changes the position of the cover 6 by moving it about the second supporting points 6a, 6b or about supporting-point line Q, against the resilience of the resilient member, in the direction where the cover is spaced apart from the optical disk. The front edge of the optical disk is consequently released from the state of abutting on the cover 6. The optical disk whose state of abutting on the cover 6 has been released is further loaded and moved into the apparatus. The above-mentioned movement of the cover 6 by the second lifter, and the loading/moving operation of the optical disk are conducted concurrently with each other.

In the meantime, the lifter 22 is actuated by the force transmitted from the lever 32, and gives, by, for example, pushing an engaging section of the unit mechanism mounting member 12, pivotal moving force for the member 12 to pivotally move about the supporting points 25, 26. This changes the position of the unit mechanism mounting member 12 by moving it upward in a direction of the top cover 8. When the unit mechanism mounting member 12 starts moving upward, the disk motor 2, the damper 3, and the disk plane support section 2a also start moving upward together, namely, the entire unit mechanism moves upward. Consequently, the convex-shaped damper 3 is inserted into the central hole of the optical disk that has already been loaded and moved into position. The disk plane support section 2a then partly abuts, for example, the planar section provided around the central hole in the optical disk. In this condition, when the unit mechanism mounting member 12 moves further upward, the optical disk also moves upward and abuts on the face of the recess 8c of the top cover 8 that is opposed to the disk. Repulsion from this opposed face then causes the damper 3 to enter the central hole in the optical disk almost completely, and the disk plane support section 2a also has, for example, its substantially entire surface abutting on the planar section provided around the central hole in the optical disk. The optical disk is thus chucked by the damper 3 and the disk plane support section 2a. In the chucked state of the disk, the front edge of the damper 3 protrudes from the through-hole 8b in the top cover 8 and is positioned above the outer planar section 8a of the top cover 8, in the disk projection region. When the unit mechanism mounting member 12 is moved upward in the foregoing, the feed motor 60 is also moved upward with the unit mechanism mounting member 12. The driving input power to the feed motor 60 is turned off during the chucking operation mentioned above. The above-mentioned vertical movement of the unit mechanism mounting member 12 or the unit mechanism including the member 12, by the first lifter up to completion of optical-disk loading, concurs with the above-mentioned movement of the cover 6 by the second lifter.

After the chucking operation, on the basis of the driving input power supplied to the motor 80, the lifter 22 changes the vertical position of the unit mechanism mounting member 12 by pivotally moving it about the supporting points 25, 26, in a direction reverse to that of the above-mentioned upward movement. Accordingly, the optical disk is spaced apart from the above-mentioned opposed face and moved downward to a desired position. Under the state where the optical disk has been lowered to the desired position, namely, a position at which the disk can be rotated for writing or reading information, the front edge of the damper 3 is positioned below the outer planar section 8b of the top cover 8, in the disk projection region. When the unit mechanism mounting member 12 is moved downward as described above above, the feed motor 60 also moves downward with the unit mechanism mounting member 12. In addition, when the optical disk is lowered to the desired position, the driving input power to the motor 80 is turned off. This allows rotation of the disk motor 2 and the feed motor 60, and hence, rotational driving of the optical disk by the disk motor 2 and movement of the optical pickup 4 by the feed motor 60. For example, when a driving pulse signal is input as a driving input signal to the feed motor 60, the feed motor rotates at a desired rotational angle or at a desired speed, thus rotating the lead screw member 71 directly coupled with the motor-rotating shaft. When the lead screw member 71 rotates, the rack 4b previously engaged with the feed screw on the surface of the lead screw member transmits the rotating force thereof to the optical pickup 4 as linear moving force. The optical pickup 4 is then guided along the guide members 72, 73 and moved through a desired distance in approximately the radial direction of the optical disk at a desired speed. While being moved in this way, the optical pickup 4 irradiates the recording surface of the optical disk with a laser beam and writes or reads information.

It is to be understood that the same reference numbers or symbols as those assigned in FIGS. 1 and 2 are used for the constituent elements of the optical disk apparatus 1 that are described below.

FIG. 3 is a plan view showing a configuration of the unit mechanism in the optical disk apparatus of FIG. 1.

In FIG. 3, reference number 100 is the optical disk chucked inside the apparatus by the damper 3 and the disk plane support section 2a, and P-P′ is a straight line (hereinafter, referred to as the supporting-point line) passing through the two supporting points 25 and 26. Meanings of other reference numbers and symbols are the same as for FIGS. 1 and 2. When the lifter 22 moves the unit mechanism mounting member 12 vertically with its end portion T as a point of action, the member 12 turns about the supporting points 25, 26, namely, supporting-point line P-P′, in a Z-axial plane. A variation in the position of the unit mechanism mounting member 12 due to the turning thereof increases as the member 12 moves away from the supporting points 25, 26, namely, supporting- point line P-P′. Symbol Y′ denotes a coordinate axis perpendicular to supporting-point line P-P′ in an X-Y plane, and X′ denotes a coordinate axis perpendicular to the coordinate axis Y′ in the X-Y plane. In the present invention, variations in the position of the feed motor 60 during turning are diminished for dimensional reduction of the apparatus, especially for reduction in thickness. For this reason, the feed motor 60 is disposed externally to the midpoint position in the radial direction of chucked optical disk 100 (i.e., a radial intermediate position on the optical disk 100 or a midpoint position between the inside diameter and outside diameter of the disk), in the projection region of the disk. That is, the position at a distance about half the radial length of the body of the feed motor 60 during turning is set externally with respect to the midpoint position in the radial direction of the optical disk. Also, the supporting points 25, 26 are provided on the outer circumferential side of the chucked optical disk 100, namely, externally to the midpoint position in the radial direction of the optical disk (i.e., a radial intermediate position on the optical disk 100 or a midpoint position between the inside diameter and outside diameter of the disk). In addition, the feed motor 60 is disposed at a position closer to the supporting points 25, 26, namely, supporting-point line P-P′, than to the midpoint position in the radial direction of the optical disk 100 (i.e., a radial intermediate position on the optical disk 100 or a midpoint position between the inside diameter and outside diameter of the disk), in the above-mentioned projection region of the disk. That is, the position at a distance about half the radial length of the body of the feed motor 60 during turning is closer to the supporting point 25, 26 than to the midpoint position in the radial direction of the optical disk. Constructing each element in this way is effective for dimensional reduction, especially for reduction in thickness. In the construction of FIG. 3, the feed motor 60 is disposed so that part thereof is positioned on or externally to supporting-point line P-P′.

FIGS. 4A and 4B illustrate disk loading into the optical disk apparatus of FIG. 1, FIG. 4A being a plan view of the apparatus with the optical disk existing halfway on the loading route, and FIG. 4B being a side view of the apparatus in that state.

In FIG. 4B, 100a denotes the recording surface of loaded optical disk 100, 100c a front edge of the optical disk 100, and 6c a plane on the surface of the cover 6. Meanings of other reference numbers and symbols are the same as for FIGS. 1 to 3. After being loaded from the loading/unloading slot in the front panel 7, the optical disk 100 has its front edge abutting on the plane 6c of the cover 6 inclined at a desired angle of θ (hereinafter, referred to as the inclination angle) with respect to the recording surface 100a of the disk 100, at a desired loading distance. The disk 100 then pushes the plane 6c of the cover 6 in a direction of arrow J against the resilience acting on the cover 6. The optical disk 100 that has pushed the plane 6c of the cover 6 in the direction of arrow J₁ undergoes the repulsion applied from the plane of the cover 6, and the repulsion regulates the optical disk 100 so that height of its recording surface becomes equal to or greater than a desired value. The optical disk 100 is further loaded and moved into the apparatus while sliding along the plane 6c of the cover 6 with the front edge 100c being maintained at approximately constant height and in an abutting condition with respect to the plane 6c. While being loaded and moved inward, the optical disk 100 is also centered. As the optical disk 100 (or the front edge 100c thereof) is being loaded and moved inward, the cover 6 moves in the direction of arrow J₁ while turning around the second supporting points 6a, 6b. The turn of the cover 6 reduces an inclination angle θ. When the desired loading/moving position is reached, the switch 50 (FIG. 2) is turned on, which supplies driving input power to the motor 80 (FIG. 2) and rotates the motor 80. The rotation of the motor 80 actuates the first lifter 22 and the second lifter (not shown) engaged with the lever 32. The second lifter changes the position of the cover 6 by turning it around the second supporting points 25, 26 or supporting-point line Q (FIG. 1). in the direction where the cover 6 is spaced apart from the recording surface 100a of the optical disk 100. In the meantime, the first lifter 22 applies turning force for the unit mechanism mounting member 12 to pivotally move around the supporting points 25, 26 or supporting-point line P-P′, whereby the member 12 moves upward while turning in a direction of arrow F, i.e., toward the top cover 8. The change in the position of the cover 6 by the second lifter, and the upward movement of the unit mechanism mounting member 12 by the first lifter 22 approximately concur with each other.

FIG. 5 is a diagram that shows relative height positions between various sections during disk loading in FIG. 4.

In FIG. 5, a horizontal axis denotes time and a vertical axis denotes height positions of movable sections. Also, symbol A denotes a curve that shows changes in height of the front end of the cover 6 with time, symbol B a curve that shows changes in height of the recording surface 100a of the optical disk 100 with time, and symbol C a curve that shows changes in height of the unit mechanism mounting member 12 with time. Symbol “a” denotes a point of disk-loading startup time at which the loading of the optical disk 100 into the apparatus is started, “b” a point of disk-cover abutting startup time at which the front edge 100c of the disk 100 and the plane 6c of the cover 6 start to abut on each other, “c” a point of unit mechanism mounting member upward movement startup time at which the unit mechanism mounting member 12 starts moving upward by an action of the first lifter 22. Symbol “d” denotes a point of disk upward movement startup time at which the optical disk 100 starts moving upward for chucking, by an action of the unit mechanism mounting member 12, and “e” a point of disk-cover abutting release startup time at which the optical disk that has started moving upward begins to move away from the plane 6c of the cover 6 (in order to be released from the abutting condition with respect to the plane 6c). Symbol “f” denotes a point of cover pulling-in startup time at which the cover 6 starts to change its position by an action of the second lifter, and “g” a point of disk rotation enabling startup time at which-the optical disk 100 is chucked and becomes rotatable. FIG. 5 assumes that before the cover 6 starts turning by the action of the second lifter, the unit mechanism mounting member 12 starts to move upward by the action of the first lifter 22.

In FIG. 5, at disk-loading startup time “a”, the optical disk 100 is loaded into the apparatus with the front edge 100c of the disk being set to a height position of Z_{B1}, and at disk-cover abutting startup time “b”, the front edge 100c of the disk 100 abuts on, and pushes, the plane 6c of the cover 6. Since the cover 6 has its front end engaged with the second lifter, when the cover is pushed, sections thereof, except for the front edge, deflect principally the section on which the front edge 100c of the disk 100 has abutted. During the deflection, the front end of the cover 6 is maintained at approximately constant height, and in this state, the cover 6 turns around the second supporting points 6a, 6b, in the direction of arrow J₁.

When the front edge 100c of the optical disk 100 is loaded into depths of the apparatus and unit mechanism mounting member upward movement startup time “c” is reached, the unit mechanism mounting member 12 starts turning around the first supporting points 25, 26 by the action of the first lifter 22 (i.e., a change of position, based on the driving force of the motor 80). The member 12 then starts gradually moving upward from a particular height position of Z_{cl}, in the direction of the top cover 8. At this time, the disk motor 2, the damper 3, the disk plane support section 2a, and other sections also move upward with the unit mechanism mounting member 12.

At disk upward movement startup time “d”, the clamper 3 and disk plane support section 2a that change in position by moving upward with the unit mechanism mounting member 12 engage with the optical disk 100 that has already reached the desired loading position. Thus, the clamper 3 and disk plane support section 2a raise the height position Z_{Bl} of the recording surface 100a of the optical disk 100 toward the top cover 8 in order to chuck the disk 100. The raise in the height position Z_{B1} gradually reduces the above deflection of the cover 6, and when disk-cover abutting release startup time “e” is reached, the deflection disappears and the front edge 100c of the optical disk 100 moves away from the plane 6c of the cover 6 and is released from the abutting state with respect to the plane 6c.

When cover pulling-in startup time “f” is further reached, the cover 6 starts to change its position by the action of the second lifter (i.e., a change of position by automatic pulling-in based on the driving force of the motor 80). This change in position turns the cover 6 around the second supporting points 6a, 6b in a direction of arrow J₂ in FIG. 4. At the same time, the height position of the front end of the cover 6 also lowers from height position Z_{A1}, toward the unit mechanism mounting member 12. The downward change in the position of the cover 6 by the automatic pulling-in operation and the upward change in the position of the optical disk 100 increase a spacing between the plane 6c of the cover 6 and the front edge 100c of the disk 100.

In the meantime, when the unit mechanism mounting member 12 arrives at height position Z_{C2} by moving upward, the recording surface 100a of the optical disk 100 is brought into height position Z_{B2}, thus causing the disk 100 to be chucked by the clamper 3 and the disk plane support section 2a. After this, the unit mechanism mounting member 12 automatically moves downward by turning about the first supporting points 25, 26, by the action of the first lifter 22, reaches height position Z_{C3} at disk rotation enabling startup time “g”, and lowers the recording surface 100a of the optical disk 100 to height position Z_{B1} to make the disk rotatable. At disk rotation enabling startup time “g”, the front end of the cover 6 is lowered to height position Z_{A2}, which is lower than height position Z_{B1} of the recording surface 100a of the disk 100. Height position Z_{C3} Of the unit mechanism mounting member 12 also becomes lower than height position Z_{B1} Of the recording surface 100a of the disk 100.

As described above, during a period between disk-cover abutting startup time “b” and disk-cover abutting release startup time “e” (i.e., in abutting duration t₁), the optical disk 100 remains abutting on the plane 6c of the cover 6, in which state, the disk is supported by the repulsion applied from the plane 6c. The height of the recording surface 100a is thus regulated to be maintained at Z_{B1}. Also, during a period between disk-cover abutting release time “e” and disk rotation enabling startup time “g” (i.e., in non-abutting duration t₂), the optical disk 100 remains in a non-abutting condition with respect to, and spaced apart from, the plane 6c of the cover 6, and in this condition, the disk is also chucked. When the optical disk 100 is unloaded from the apparatus, a period during which the disk 100 remains abutting on the plane 6c of the cover 6 is also formed and in this period, the height of the recording surface 100a is regulated to be maintained.

FIG. 6 is an enlarged view of section G in FIG. 2, illustrating a portion of the second lifter for moving the cover 6 vertically. FIGS. 7A to 7C are operation explanatory diagrams of section G.

In FIGS. 6 and 7A-7C, 90 denotes a cam member, 90a a cam section thereof, 90b a supporting point for turning of the cam member 90a, 90c the engaging section of the cam member 90 that engages with the cover 6, 95 a resilient member for energizing the cam member 90 in the direction where the inclination angle θ shown in FIG. 4B is increased, and 32a the cam-engaging section of the lever 32 that engages with the cam section 90a of the cam member 90. The cam member 90, the resilient member 95, and the cam-engaging section of the lever 32 constitute the second lifter. The supporting points 6a, 6b for turning of the cover 6 are provided on the unit mechanism mounting member 12 in the configuration of the present embodiment.

When the optical disk is positioned halfway on its loading route within the apparatus, the lever 32 is actuated by the force transmitted from the transmission 21 (FIG. 2), and drives the second lifter. That is to say, the lever 32 moves in a direction of arrow K shown in FIG. 7A, the cam-engaging section 32a at a front end of the lever 32 engages with the cam section 90a of the cam member 90, and the engagement causes the cam member 90 to turn about the supporting point 90b against resilience of the resilient member 95 and thus to move in a direction of arrow L. The movement of the cam member 90 in the direction of arrow L causes the cover 6 in engagement with the engaging section 90c to move in the direction of arrow J₁ shown in FIG. 7B. When the lever 32 further moves in the direction of arrow K, the cam-engaging section 32a of the lever 32 operates to get over a maximal section 90a₁ of an engaging route curve of the cam section 90a of the cam member 90 and settles down at a stable position. In response to the getting-over operation of the cam-engaging section 32a, the cam member 90 moves to change a position of the cover 6 and holds the position, as shown in FIG. 7C.

FIG. 8 is an explanatory diagram of disk chucking in the optical disk apparatus of FIG. 1. FIG. 8 shows the optical disk 100 that has already been chucked with the recording surface 100a thereof at height position Z_{B2} (FIG. 5).

In FIG. 8, 100 denotes the optical disk, 8_{c1} the face of the recess 8c of the top cover 8 that is opposite to the surface of the optical disk 100 (hereinafter, this face is referred to as the outer plane of the recess 8c in the top cover 8), and 8c₂ the face of the recess 8c of the top cover 8 that is opposed to the optical disk 100 (hereinafter, this face is referred to as the inner plane of the recess 8c in the top cover 8). Reference number 85 denotes the loading/unloading slot for the optical disk 100, provided in the front panel 7. Arrow F₁ denotes a direction in which the unit mechanism mounting member 12 pivotally moves upward, arrow F₂ a direction in which the unit mechanism mounting member 12 pivotally moves downward, arrow F₁′ a direction in which the feed motor 60 turns to move upward with the unit mechanism mounting member 12, and arrow F₂′ a direction in which the feed motor 60 turns to move downward with the unit mechanism mounting member 12. Symbol h₁ denotes a vertical distance from the side (in the disk projection region) of the top cover's outer planar section 8a that faces the supporting points 25, 26, to the front edge of the clamper 3, and symbol h₂ denotes a vertical distance from the side (in the disk projection region) of the top cover's outer planar section 8a that is formed in a direction opposite to the supporting points 25, 26, namely, the lifter 22, to the front edge of the clamper 3; wherein h₁ =the amount of protrusion of the front edge of the clamper 3 from the outer planar section 8a, h₂ =the amount of protrusion of the front edge of the clamper 3 from the outer planar section 8a, and h₂>h₁.

The lifter 22 lifts the unit mechanism mounting member 12, and the optical disk 100 abuts on the inner plane 8c₂ of the recess 8c in the top cover 8. Consequent repulsion from the inner plane 8c₂ causes the clamper 3 to enter the central hole in the optical disk 100 almost completely. Also, for instance, almost the entire surface of the disk plane support section 2a (not shown in FIG. 3) on the rotating section of the disk motor 2 abuts the planar section provided around the central hole in the optical disk 100. When the optical disk 100 is thus chucked, the front edge of the clamper 3 protrudes from the through-hole 8b in the top cover 8, over the outer plane 8c₁ thereof, and height of the front edge is set to range from h₁ to h₂, above the outer planar section 8a of the top cover 8, in the disk projection region. After the optical disk 100 has been chucked, the unit mechanism mounting member 12 moves downward in a direction of arrow F₂, whereby the clamper 3 also moves downward. After moving downward to a desired vertical position, the optical disk 100 becomes rotatable for writing or reading. Along with the construction in which, as described above, the feed motor 60 is disposed on the outer circumferential side of the optical disk 100 or at a position near the supporting points 25, 26, the construction that causes the front edge of the clamper 3 to protrude over the vertical position of the outer planar section 8a of the top cover 8 in the above manner during disk chucking enables height of the outer planar section 8a of the top cover 8 to be reduced below the height of the front edge of the clamper 3, and thus reduces the top cover 8 in height. This allows the optical disk apparatus 1 to be dimensionally reduced, especially, in thickness. In the optical disk apparatus 1 having the construction described in FIGS. 1 to 4A and 4B, for example, when both h₁ and h₂ are set to be 0.5×10⁻³ m or less, the downward movement of the clamper 3 after the disk has been chucked allows the front edge of the clamper 3 to be positioned below the outer planar section 8a of the top cover 8. As a result, the entire optical disk apparatus 1 can also have its thickness suppressed to 9.5×10⁻³ m or less.

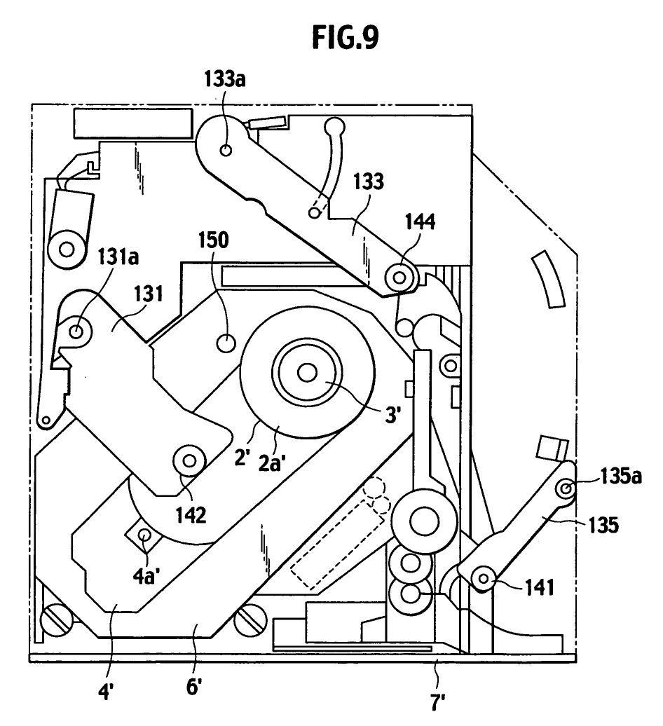

According to the above-described embodiment of the present invention, it is possible to ensure the desired height of the optical disk 100 by using the cover 6, without providing a special member such as the guide shaft 150 (FIG. 9). Dimensional reduction of the apparatus, especially, further reduction in its thickness can therefore be achieved, which in turn makes it possible, in the slot-in type of optical disk apparatus, for example, to reduce a distance between the outer surface of the top cover 8 and that of the bottom cover 10, to 9.5×10⁻³ or less. Additionally, the apparatus can be further reduced in dimensions, especially, in thickness, by combining: the configuration in which the feed motor 60 is disposed at an outer circumferential position of the optical disk 100 or a position near the supporting points 25, 26 (or supporting-point line P-P′) on the outer circumferential side of the disk, in the projection region thereof; and the construction that causes the front edge of the clamper 3 to protrude from the through-hole 8b in the top cover 8 and thus to be positioned above the outer planar section 8a thereof.

It has been described in the above embodiment that before the cover 6 starts turning by the action of the second lifter, the unit mechanism mounting member 12 starts to move upward by the action of the first lifter 22 (see FIG. 5). However, the present invention is not limited to this construction. It has also been described in the above embodiment that only the cover 6 of the two covers, 5 and 6, can be moved. However, the present invention is not limited to this construction. In addition, the above cover has been described as using a resilient member and having a construction in which the cover is urged by the resilience of the resilient member in the direction where the inclination of the plane of the cover to the plane of the optical disk is increased. However, the present invention is not limited to such construction, and the cover may be constructed so that it is urged by, for example, resilience of the cover itself, without using a resilient member. Furthermore, although a slot-in type of optical disk apparatus has been described as the above embodiment, the present invention is not limited to this type of apparatus.

Without departing from its spirit or its major features, the present invention can likewise be embodied in modes other than the above. In all respects, therefore, the above embodiment is merely an example of the invention and is not to be understood in limited fashion. The scope of the invention is specified by claims. Additionally, all modifications and changes belonging to equivalents of the claims stay within the scope of the invention.

What is claimed is:

1. An optical disk apparatus for writing or reading information by moving an optical pickup in approximately a radial direction of an optical disk, said apparatus comprising:
a unit mechanism having thereon:
a disk motor for rotationally driving the optical disk;
said optical pickup;
a moving/guiding mechanism for moving said optical pickup while guiding said optical pickup in approximately the radial direction of the optical disk; and
a feed motor for driving said moving/guiding mechanism; and
a cover adapted to be movable about a supporting point, wherein said cover covers said unit mechanism;
wherein, when the optical disk is loaded into said apparatus, a front edge of the optical disk is allowed to abut on a plane of said cover inclined in a crossing direction with respect to a plane of the optical disk, thus a position of said cover is changed, and a height position of the optical disk is regulated on the basis of the resulting repulsion.

2. An optical disk apparatus for writing or reading information by moving an optical pickup in approximately a radial direction of an optical disk, said apparatus comprising:
a unit mechanism having thereon:
a disk motor for rotationally driving the optical disk;
said optical pickup;
a moving/guiding mechanism for moving said optical pickup while guiding said optical pickup in approximately the radial direction of the optical disk; and
a feed motor for driving said moving/guiding mechanism;
a cover adapted to be movable about a supporting point, wherein said cover covers said unit mechanism; and
a lifter which, prior to chucking of the optical disk, when the optical disk is present at a desired position halfway on a loading route within said apparatus, moves said cover about a supporting point by applying force to said cover;
wherein, when the optical disk is loaded into said apparatus, a front edge of the optical disk loaded is allowed to abut on a plane of said cover inclined in a crossing direction with respect to a plane of the optical disk, and thus a height position of a recording surface of the optical disk is regulated, and when the optical disk is present in a desired loading position, said lifter moves said cover in the direction where said cover moves away from the optical disk.

3. An optical disk apparatus for writing or reading information by moving an optical pickup in approximately a radial direction of an optical disk, said apparatus comprising:
a disk motor for rotationally driving the optical disk that has been chucked at a desired position within said apparatus;
a first base as a apparatus base;
a moving/guiding mechanism for moving said optical pickup while guiding said optical pickup in approximately the radial direction of the optical disk;
a second base on which said optical pickup, said moving/guiding mechanism, and said disk motor are mounted, wherein said second base is adapted to turn about a first supporting point disposed more externally to a midpoint position in a radial direction of the chucked optical disk than to said first base;
a cover adapted to move about a second supporting point disposed at a position closer to the first supporting point than to a central axis position of said disk motor, and to cover said moving/guiding mechanism;
a first lifter provided at said first base, wherein, prior to chucking of the optical disk, when the optical disk is in a loaded condition at a desired position within said apparatus, said first lifter moves said second base about the first supporting point by applying force to said second base;
a second lifter which, prior to the chucking of the optical disk, when the optical disk is present at a desired position halfway on a loading route within said apparatus, moves said cover about the second supporting point by exerting force on said cover;
a lifter motor which drives said first lifter and said second lifter;
switch means which turns the driving of said lifter motor on and off; and
a moving member which moves to activate and deactivate said switch means;
wherein, when the optical disk is loaded thereinto, a front edge of the optical disk is allowed to abut on a plane of said cover inclined in a crossing direction with respect to a plane of the optical disk, and thus a height position of a recording surface of the optical disk is regulated, and upon arrival of the optical disk at a desired loading position, said moving member activates said switch means, moves said second base toward the optical disk by an action of said first lifter, and moves said cover by an action of said second lifter, in a direction where said cover moves away from the optical disk.

4. An optical disk apparatus that writes or reads information by rotating an optical disk in a concentrically chucked condition on a rotating shaft of a disk motor and moving an optical pickup in approximately a radial direction of the optical disk, said apparatus comprising:
a convex-shaped clamper disposed on a rotating section of said disk motor, wherein, when the optical disk is chucked, said clamper is inserted into a central hole of the optical disk and supports the optical disk in a radial direction;
a disk plane support section disposed concentrically with said clamper, on the rotating section of said disk motor, wherein, with said clamper inserted within the central hole of the optical disk, said support section supports a planar section of the optical disk;
a top cover disposed above said clamper, wherein said top cover has a through-hole at a position opposed to said clamper and covers the surface side of said apparatus;
a bottom cover which covers the reverse side of said apparatus;
a unit mechanism having thereon:
a disk motor for rotationally driving the optical disk;
said optical pickup;
a moving/guiding mechanism for moving said optical pickup while guiding said optical pickup in approximately the radial direction of the optical disk; and
a feed motor for driving said moving/guiding mechanism, wherein said unit mechanism turns about a first supporting point;
a first lifter which causes the turning of said unit mechanism around the first supporting point;
a cover adapted to be movable about a second supporting point, wherein said cover covers said unit mechanism; and
a second lifter which, prior to the chucking of the optical disk, when the optical disk is present at a desired position halfway on a loading route within said apparatus, moves said cover about the second supporting point by exerting force on said cover;
wherein, when the optical disk is loaded thereinto, a front edge of the optical disk is allowed to abut on a plane of said cover inclined in a crossing direction with respect to a plane of the optical disk, and thus a height position of a recording surface of the optical disk is regulated, and upon arrival of the optical disk at a desired loading position, after said second lifter is activated to move said cover in a direction where said cover moves away from the optical disk, and after said first lifter is activated to lift said unit mechanism for the optical disk to abut on an opposed face of said top cover, a front edge of said clamper is caused to protrude from a through-hole in said top cover and thus to be positioned above a height position of a planar section thereof in a disk projection region.

5. The optical disk apparatus according to claim 1, wherein, on said unit mechanism, said feed motor is disposed externally to a midpoint position in the radial direction of the optical disk, in a projection region of the optical disk in its chucked condition.

6. The optical disk apparatus according to claim 2, wherein, on said unit mechanism, said feed motor is disposed externally to a midpoint position in the radial direction of the optical disk, in a projection region of the optical disk in its chucked condition.

7. The optical disk apparatus according to claim 4, wherein, on said unit mechanism, said feed motor is disposed externally to a midpoint position in the radial direction of the optical disk, in a projection region of the optical disk in its chucked condition.

8. The optical disk apparatus according to claim 1, wherein, on said unit mechanism, said feed motor is disposed externally to a midpoint position in the radial direction of the optical disk, in a projection region of the optical disk in its chucked condition.

9. The optical disk apparatus according to claim 2, wherein, on said unit mechanism, said feed motor is disposed externally to a midpoint position in the radial direction of the optical disk, in a projection region of the optical disk in its chucked condition.

10. The optical disk apparatus according to claim 4, wherein, on said unit mechanism, said feed motor is disposed externally to a midpoint position in the radial direction of the optical disk, in a projection region of the optical disk in its chucked condition.

11. The optical disk apparatus according to claim 1, wherein said cover has its supporting point disposed externally to a midpoint position in a radial direction of the optical disk in its chucked condition.

12. The optical disk apparatus according to claim 2, wherein said cover has its supporting point disposed externally to a midpoint position in a radial direction of the optical disk in its chucked condition.

13. The optical disk apparatus according to claim 1, wherein said cover is adapted to be urged by resilience to move in the direction where the inclination increases.

14. The optical disk apparatus according to claim 2, wherein said cover is adapted to be urged by resilience to move in the direction where the inclination increases.

15. The optical disk apparatus according to claim 3, wherein said cover is adapted to be urged by resilience to move in the direction where the inclination increases.

16. The optical disk apparatus according to claim 4, wherein said cover is adapted to be urged by resilience to move in the direction where the inclination increases.

17. The optical disk apparatus according to claim 4, wherein a maximum distance between an outer face of said top cover and an outer face of said bottom cover is 9.5×10⁻³ m.
